(19) United States
(12) Patent Application Publication
(10) Pub. No.: US 2024/0265327 A1
(43) Pub. Date: Aug. 8, 2024

(54) RISK ASSESSMENT SYSTEM AND METHOD FOR EVALUATING AND SCORING SMALL BUSINESSES ENGAGED IN CROSSBORDER TRADE

(71) Applicant: Azam Pasha, Dubai (AE)

(72) Inventors: Azam Pasha, Dubai (AE); Rohit Majhi, Pune (IN)

(21) Appl. No.: 18/430,261

(22) Filed: Feb. 1, 2024

Related U.S. Application Data
(60) Provisional application No. 63/442,941, filed on Feb. 2, 2023.

(51) Int. Cl. G06Q 10/0635; G06Q 10/0639; G06Q 30/018

(52) U.S. Cl. CPC G06Q 10/0635; G06Q 10/06393; G06Q 30/018; G06Q 2220/00

(57) ABSTRACT

The risk assessment system for evaluating and scoring small businesses engaged in cross-border trade, includes a computer system connected to one or more buyer devices, one or more seller devices, an Internet of Things (IoT) module and a blockchain framework. The computer system functions to receive various data inputs, including user-uploaded, third-party, and platform data and employs an optical character recognition (OCR) data extractor to process these inputs and utilizes artificial intelligence (AI) models to generate processed data. The computer system further calculates a transaction history score by analyzing payment discrepancies and integrates IoT data for comprehensive risk assessment. Utilizing a proprietary risk scoring model, the computer system generates a buyer risk score or a seller performance score, ranging from 1 to 1000, providing a dynamic and data-driven solution for risk evaluation in international trade. The respective scores may then be displayed on the buyer and seller devices.

### CROSS REFERENCE TO RELATED APPLICATION

The present application is a non-provisional application based on, and claims priority from U.S. patent application Ser. No. 63/442,941, filed on Feb. 2, 2023.

### TECHNICAL FIELD

Embodiments of the present invention generally relate to trade and finance technologies and more particularly to a risk assessment system and a method for evaluating and scoring small businesses engaged in cross-border trade.

### BACKGROUND OF THE INVENTION

The subject matter discussed in the background section should not be assumed to be prior art merely as a result of it being mentioned in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the dynamic sector of cross-border trade, particularly in the exchange of food and agriproducts, stakeholders face considerable challenges in assessing the risks associated with buyer payment and seller performance. Traditional risk assessment methods often rely on limited financial metrics and historical data, which may not provide a comprehensive picture of a business's current and future reliability. Furthermore, the increasing volume and velocity of trade transactions demand more agile and real-time risk assessment solutions.

Existing systems frequently fail to incorporate real-time data or non-financial indicators that can significantly impact a business's risk profile. For instance, shipment conditions monitored through IoT devices or nuanced data captured on trading platforms can offer critical insights into the performance and behavior of trading entities. Traditional models also often lack sufficient data security measures, exposing sensitive financial and operational data to potential breaches.

Additionally, these models do not adapt dynamically to the constantly changing landscape of international trade, where new data can emerge rapidly, necessitating immediate reflection in a business's risk score. This leads to a lag between the actual risk and its assessment, making the process less effective for decision-makers who rely on up-to-date information to mitigate risks in cross-border transactions. To sum it up, the limitations of the current risk assessment solutions include:
Inadequate integration of diverse data types, particularly real-time and non-financial data.
Insufficient security and privacy measures to protect the integrity of the data used in risk assessments.
Lack of adaptability and real-time updating mechanisms to reflect the latest transactional data and market conditions.
Failure to provide a user-friendly interface for stakeholders to interact with and understand risk assessments.

There exists a need for a risk assessment system and a method for evaluating and scoring small businesses engaged in cross-border trade that is capable of not only incorporating a wide range of data types, including IoT and platform-generated data, but also ensuring the security of this data through advanced technologies like blockchain. Such a system should dynamically update risk scores, offer insights derived from machine learning analysis, and cater specifically to the nuanced needs of small businesses in cross-border trade.

By addressing these challenges, the solution should be able to revolutionize the field of risk assessment in international trade, providing stakeholders with a reliable, secure, and comprehensive tool for making informed decisions and fostering trust in cross-border commercial activities.

### SUMMARY OF THE INVENTION

According to a first aspect of the present invention, there is provided a risk assessment system for evaluating and scoring small businesses engaged in cross-border trade. The risk assessment system comprises, but not limited to, one or more buyer devices associated with respective buyers; one or more seller devices associated with respective sellers; an Internet of Things (IoT) module to gather shipment related data as IoT data; a blockchain framework for securing all data; and a computer system associated with a platform for facilitating cross-border trade of food and agriproducts. The computer system is connected with the one or more buyer devices and the one or more seller devices. Herein, the computer system includes a processor; and a memory unit configured to store machine readable instructions that, when executed by the processor, cause the computer system to receive, via the one or more buyer devices and the one or more seller devices, a plurality of data inputs including user-uploaded data, third-party data, and platform data; extract relevant information from the plurality of data inputs using an optical character recognition (OCR) data extractor; process the extracted information with artificial intelligence (AI) models to generate processed data; secure the processed data using blockchain framework; calculate a transaction history score based on discrepancies between contracted and actual values of payment using the secured data; integrate IoT data related to shipment conditions into the transaction history score; apply a proprietary risk scoring model to the secured processed data and the IoT data; and generate a buyer risk score or a seller performance score ranging from 1 to 1000 based on the application of the proprietary risk scoring model.

In accordance with an embodiment of the present invention, the user-uploaded data includes at least financial statements, rental agreements, national identification documents, and credit bureau reports.

In accordance with an embodiment of the present invention, the third-party data includes at least business registration licenses and VAT/GST filing statements.

In accordance with an embodiment of the present invention, the platform data is obtained from a trade platform that facilitates cross-border transactions.

In accordance with an embodiment of the present invention, the IoT data includes at least temperature, humidity, shock, and luminance data during shipment.

In accordance with an embodiment of the present invention, the computer system is further configured to update the buyer risk score or the seller performance score in real-time based on new data inputs.

In accordance with an embodiment of the present invention, blockchain framework comprises an immutable ledger configured to record the transaction history and processed data.

In accordance with an embodiment of the present invention, the proprietary risk scoring model includes pre-trained machine learning models configured to analyze the processed data and IoT data.

In accordance with an embodiment of the present invention, user interfaces on the one or more buyer devices and the one or more seller devices are configured to display the buyer risk score or the seller performance score, respectively.

In accordance with an embodiment of the present invention, the one or more buyer devices and one or more seller devices are selected from a laptop, mobile, a wearable watch or band, a desktop and a portable handheld device, having computing capabilities.

According to a second aspect of the present invention, there is provided a computer-implemented method for evaluating and scoring small businesses engaged in cross-border trade of food and agriproducts. The computer-implemented method comprises, but not limited to, receiving, via one or more buyer devices and one or more seller devices, a plurality of data inputs including user-uploaded data, third-party data, and platform data; extracting relevant information from the plurality of data inputs using an optical character recognition (OCR) data extractor; processing the extracted information with artificial intelligence (AI) models to generate processed data; securing the processed data using a blockchain framework; calculating a transaction history score based on discrepancies between contracted and actual values of payment using the secured data; integrating Internet of Things (IoT) data related to shipment conditions into the transaction history score; applying a proprietary risk scoring model to the secured processed data and the IoT data; and generating a buyer risk score or a seller performance score ranging from 1 to 1000 based on the application of the proprietary risk scoring model.

In accordance with an embodiment of the present invention, the user-uploaded data includes at least financial statements, rental agreements, national identification documents, and credit bureau reports.

In accordance with an embodiment of the present invention, the third-party data includes at least business registration licenses and VAT/GST filing statements.

In accordance with an embodiment of the present invention, the platform data is obtained from a trade platform that facilitates cross-border transactions.

In accordance with an embodiment of the present invention, the IoT data includes at least temperature, humidity, shock, and luminance data during shipment.

In accordance with an embodiment of the present invention, the computer-implemented method further comprises updating the buyer risk score or the seller performance score in real-time as new data inputs are received.

In accordance with an embodiment of the present invention, the blockchain framework comprises an immutable ledger configured to record the transaction history and processed data.

In accordance with an embodiment of the present invention, the proprietary risk scoring model includes pre-trained machine learning models configured to analyze the processed data and IoT data.

In accordance with an embodiment of the present invention, the computer-implemented method further comprises displaying the buyer risk score or the seller performance score on user interfaces of the one or more buyer devices and the one or more seller devices, respectively.

In accordance with an embodiment of the present invention, the one or more buyer devices and one or more seller devices are selected from a group comprising a laptop, mobile, a wearable watch or band, a desktop, and a portable handheld device with computing capabilities.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a risk assessment system for evaluating and scoring small businesses engaged in cross-border trade, in accordance with an embodiment of the present invention;

FIG. 2 illustrates risk assessment method for evaluating and scoring small businesses engaged in cross-border trade, in accordance with an embodiment of the present invention; and

FIG. 3A-3B illustrate information flow diagrams showcasing an exemplary implementation of the risk assessment system and method of FIGS. 1 and 2, in accordance with an embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed. Still, on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed after that, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like is included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element, or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims.

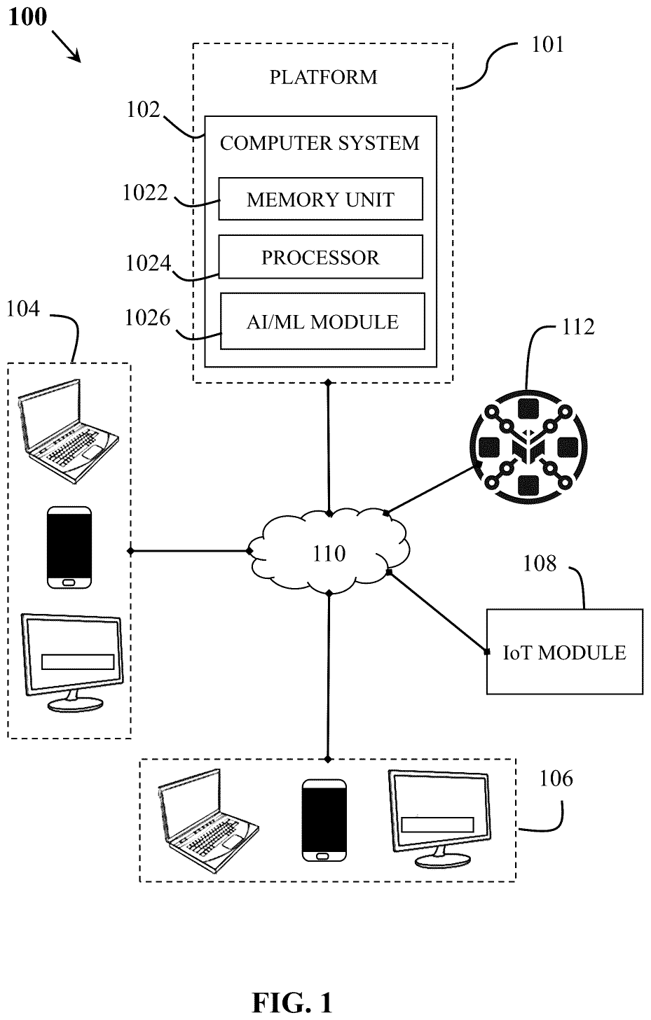

Referring to the drawings, the invention will now be described in more detail. FIG. 1 illustrates a risk assessment system for evaluating and scoring small businesses engaged in cross-border trade, in accordance with an embodiment of the present invention. As shown in FIG. 1, the risk assessment system 100 comprises, but not limited to, one or more buyer devices 104 associated with respective buyers; one or more seller devices 106 associated with respective sellers; an Internet of Things (IoT) module to gather shipment related data as IoT data; a blockchain framework 112 for securing all data; and a computer system 102 connected with the one or more buyer devices 104, the one or more seller devices 106, the IoT module 108 and the blockchain framework 112, via a communication network 110. The computer system 102 is associated with a platform 101 for facilitating cross-border trade of food and agriproducts.

Herein, the platform 101 associated with the computer system 102 serves as a digital nexus for facilitating and streamlining cross-border trade of food and agriproducts. Designed to act as a comprehensive marketplace and risk assessment tool, this platform 101 brings together buyers and sellers from diverse geographic locations, enabling them to engage in trade with greater confidence and reduced risk. It provides a suite of services that includes transaction processing, document verification, and real-time risk evaluation, all aimed at fostering transparent and secure international commerce. The computer system 102 that powers this platform 101 is versatile and designed to operate across a range of operating systems, ensuring wide accessibility and seamless functionality. The platform 101 is capable of running on Windows, macOS, Linux, or various mobile operating systems, thereby ensuring flexibility to operate on different devices as well as consistent performance and user experience across different technological environments. This capability ensures that stakeholders can rely on the platform 101 for their risk assessment needs regardless of their preferred technology ecosystem.

Returning to FIG. 1, The depicted embodiment includes various hardware components that are integral to the risk assessment system's 100 operation, each with distinct capabilities and connections to other components within the risk assessment system 100. Each component will now be discussed in detail below:

As can be seen from the FIG. 1, the brain of the risk assessment system 100 is the computer system 102. In that sense, the computer system 102 may be envisioned as the central processing unit of the risk assessment system 100. It comprises a processor and a memory unit. The processor is a critical component that executes machine-readable instructions stored within the memory unit. The processor may be one of, but not limited to, a general-purpose processor, an application-specific integrated circuit (ASIC), or a field-programmable gate array (FPGA).

The memory unit of the computer system 102 is configured to store machine-readable instructions that, when executed by the processor, enable the computer system 102 to perform a multitude of functions relevant to the risk assessment process. The memory unit can be selected from a group comprising, but not limited to, Electrically Programmable Read-Only Memory (EPROM), Electrically Erasable Programmable Read-Only Memory (EEPROM), and Flash memory. The memory unit can be loaded with machine-readable instructions from a non-transitory machine-readable medium, such as, but not limited to, CD-ROMs, DVD-ROMs, and Flash Drives. Alternatively, the machine-readable instructions can be loaded in the form of a computer software program into the memory unit.

The computer system 102 may also include a communication module (not shown) specifically designed to enable wireless connections with the one or more buyer devices 104, and the one or more seller devices 106 over the communication network 110. The communication module is pivotal in facilitating seamless wireless communication within the risk assessment system 100, ensuring that data transfer and interactions between these components are efficient and secure. The wireless capabilities of the communication module extend to its integration with IoT module 108 and the blockchain framework 112, essential for the real-time data processing and secure data handling required by the risk assessment system 100. The module supports various wireless communication protocols, such as Wi-Fi, Bluetooth, and NFC (Near Field Communication), allowing for flexible and robust connectivity options. These protocols enable the computer system 102 to maintain continuous and reliable wireless connections, which are vital for the dynamic updating and real-time data processing functionalities of the risk assessment system 100.

In that sense, the communication network 110 can be a short-range communication network 110 and/or a long-range communication network 110. The communication interface includes, but is not limited to, a serial communication interface, a parallel communication interface, or a combination thereof. The communication network 110 enables the seamless transfer of data and instructions between the components of the risk assessment system 100. It may utilize various communication protocols and technologies, including, but not limited to, the Internet, intranets, virtual private networks (VPNs), and cloud-based services, ensuring that the risk assessment system 100 remains connected and responsive to the needs of the users.

The computer system 102 is equipped with an optical character recognition (OCR) module. The OCR module is responsible for converting various types of documents and images received from the one or more buyer devices 104 and the one or more seller devices 106 into machine-readable text. This module is crucial for extracting critical information from financial statements, identification documents, and other paperwork that are integral to the risk assessment process.

Further, Artificial intelligence (AI) and machine learning (ML) capabilities are envisaged to be embedded within the computer system 102, forming an AI/ML module 1026. This module utilizes pre-trained machine learning models to process and analyze the data extracted by the OCR module. The AI/ML module 1026 is adept at identifying patterns, making predictions, and deriving insights that are essential for calculating the risk scores. Several machine learning techniques can be employed within this system, each offering specific advantages in the context of risk assessment for cross-border trade:
Neural Networks: Particularly useful for handling complex patterns in large datasets, neural networks can analyze the non-linear relationships between various risk factors and outcomes. This technique is adept at processing unstructured data, such as text from financial statements or operational reports, providing a deep understanding of the risk factors associated with each business.
Decision Trees: By employing decision trees, the risk assessment system 100 can make logical, step-by-step decisions about the risk level of a business. This technique is beneficial for breaking down complex decision-making processes into simpler, more manageable parts, making it easier to understand how specific data points impact the overall risk score.
Support Vector Machines (SVM): SVMs are effective in classifying businesses into different risk categories. They work well in high-dimensional spaces, which is typical of the data environment in cross-border trade, where numerous factors influence risk.
Ensemble Methods: Techniques like Random Forests and Gradient Boosting can be utilized to improve prediction accuracy. These methods combine multiple learning algorithms to obtain better predictive performance than could be obtained from any of the constituent learning algorithms alone.
Clustering Algorithms: For segmenting businesses into various risk groups based on similar characteristics, clustering algorithms like K-Means or Hierarchical Clustering can be applied. This helps in identifying patterns and correlations that might not be evident through traditional analysis.
Anomaly Detection Algorithms: To identify outliers or unusual patterns in transaction data that might indicate increased risk or potential fraud, anomaly detection algorithms can be crucial.
Foundational Models: These are versatile, large-scale models trained on extensive datasets that provide a robust foundation for various AI tasks. In risk assessment, foundational models can adapt to different types of data inputs, enhancing the system's ability to generalize and apply learned patterns across diverse scenarios in cross-border trade.
Large Language Models (LLMs): LLMs, such as GPT (Generative Pre-trained Transformer), are highly effective in processing and understanding natural language data. In the context of the risk assessment system, LLMs can analyze textual data from business communications and operational reports, extracting nuanced insights that contribute to a more accurate risk profile of the businesses involved.

The AI/ML module 1026, serves as one of the core components of the computer system 102, processes the data inputs from various sources, including the one or more buyer devices 104 and one or more seller devices 106, as well as third-party and platform 101 data.

FIG. 1 also illustrates the blockchain framework 112 associated with the computer system 102. This blockchain framework 112 is foundational to the risk assessment system's 100 security architecture, primarily serving to record transactions and processed data with unparalleled integrity. At its core, the framework consists of an immutable ledger, an essential feature for ensuring the authenticity and accuracy of the data utilized in the risk assessment process.

The immutable nature of the blockchain ledger means that once a transaction or data point is recorded, it cannot be altered or deleted, thus providing a permanent and tamper-proof record. This characteristic is particularly important in the context of risk assessment for cross-border trade, where the reliability of transactional and business data is paramount.

In addition to its immutability, the blockchain framework 112 offers several other key features in the present invention:
Decentralization: Unlike traditional centralized databases, the blockchain ledger is distributed across multiple nodes, reducing the risks associated with centralized data storage and enhancing system resilience.
Transparency: Each transaction recorded on the blockchain is visible to all participants in the network, fostering transparency in the risk assessment process. This visibility is crucial for building trust among stakeholders, as it allows for the verification of the data inputs that contribute to risk scores.
Security: The use of cryptographic techniques in blockchain ensures that the data is securely encrypted, safeguarding sensitive information from unauthorized access and potential breaches.
Traceability: The blockchain framework 112 provides an audit trail for the data it records. This feature is particularly valuable in tracing the history of transactions and data changes, contributing to a more thorough and accurate risk assessment.

The integration of the blockchain framework 112 within the computer system 102, as illustrated in FIG. 1, underlines the invention's commitment to leveraging advanced technology to enhance the risk assessment process. By providing a secure, transparent, and efficient means of handling data, the blockchain framework 112 significantly contributes to the reliability and effectiveness of the risk scoring system in the context of international trade.

Furthermore, the computer system 102 is shown to interface with Internet of Things (IoT) module 108. The Internet of Things (IoT) module 108 is envisaged to enhance the depth and accuracy of the risk assessment process. The IoT module 108 is designed to aggregate real-time data from multiple sources, providing a comprehensive view of various factors that could influence the risk associated with cross-border trade transactions.

Following are a few exemplary sources of IoT Data Sources:
Temperature Sensors: Positioned within transportation vehicles or storage facilities, these sensors provide real-time data on the ambient temperature, crucial for perishable goods like food products.
Humidity Sensors: Similar to temperature sensors, these are used to monitor moisture levels in the environment, particularly important for products sensitive to humidity.
GPS Trackers: Installed on shipping containers or vehicles, GPS trackers offer real-time location data, allowing for the tracking of goods in transit and ensuring they are following the intended routes.
Shock Sensors: These sensors detect and record instances of excessive force or impact that might occur during shipping, providing insights into the handling quality of the goods.
Light Exposure Sensors: Used to monitor the exposure of goods to light, particularly important for products sensitive to light and UV radiation.
RFID Tags: Radio-Frequency Identification tags on products or pallets provide data on inventory movement and can be used to verify the authenticity and origin of the goods.
Gas Sensors for Ethylene and CO2 Emissions: These sensors are essential for monitoring the levels of ethylene and carbon dioxide, especially in the context of shipping perishable agricultural products. Ethylene gas sensors can detect the presence of this plant hormone, which is crucial for understanding the ripening and spoilage processes of fruits and vegetables during transit. Similarly, CO2 sensors can monitor carbon dioxide levels, which are indicative of product respiration rates and overall freshness. The integration of data from these sensors into the IoT module 108 adds another layer of precision in assessing the risk of spoilage and maintaining the quality of perishable goods throughout the supply chain.

Besides, the sources may also be selected from, but not limited to, touch based sensors, heat sensors, infrared sensors, ultrasonic sensors, laser sensors, weight sensors, photo electric sensors, pulse sensor, and light sensors. The integration of data from all these sources into the IoT module 108 allows for the collection and analysis of critical logistical parameters in real-time. For example, the temperature and humidity data can be crucial for assessing the risk of spoilage for food products during transit. Similarly, data from shock sensors can indicate potential mishandling or damage to goods, influencing the seller performance score.

Once collected, this IoT data is processed by the computer system 102, where it is correlated with other key business and transactional data. The risk assessment system's 100 AI/ML models analyze this composite data set to assess potential operational risks, such as the likelihood of product damage or spoilage, and the reliability of the delivery process. This analysis contributes significantly to the dynamic scoring system, where factors like shipment conditions are weighted and integrated into the overall risk score.

This IoT data integration not only enhances the accuracy of risk assessments but also introduces a level of granularity previously unattainable with traditional risk assessment methods. By considering these real-time, logistical parameters, the risk assessment system 100 provides a more nuanced and comprehensive view of the risks inherent in cross-border trade of food and agriproducts.

The inclusion of such diverse and real-time data sources in the IoT module 108 underscores the innovative approach of the present invention, leveraging cutting-edge technology to address the complex challenges of international trade risk assessment. This aspect of the invention, integrated with the risk assessment system's 100 wireless communication capabilities, blockchain framework 112, and advanced machine learning techniques, forms a holistic solution that significantly improves the decision-making process for stakeholders in cross-border trade scenarios.

Additionally, the one or more buyer devices 104 and the one or more seller devices 106 as shown in FIG. 1, play a pivotal role in the present invention. These devices may encompass a range of computing devices, including, but not limited to, desktop PCs, laptops, PDAs, and handheld computing devices such as smartphones and tablets. Each device is equipped with microprocessors that facilitate processing and communication capabilities, enabling them to interface seamlessly with the computer system 102 through both wired and wireless connections. In certain embodiments of the invention, these buyer and seller devices 106 are more than mere conduits for data input and output; they may themselves house the processor along with their inherent functionalities. This embodiment allows for a versatile application of the invention, where the processing power is not confined to a central computer system 102 but distributed across various buyer and seller devices 106.

In accordance with an embodiment of the present invention, the one or more buyer devices 104 and the one or more seller devices 106 are registered with the risk assessment system 100, which is crucial for ensuring secure and personalized user interaction. During the registration process, the one or more buyer devices 104 and one or more seller devices 106 capture and submit essential details to the computer system 102. This information can range from basic identification data, such as usernames and contact numbers, to more specific details like areas of interest, business information, and product specifications. In order to enhance the security and integrity of the risk assessment system 100, the registration process may also incorporate biometric authentication methods. These methods could include, but are not limited to, fingerprint recognition, face recognition, and iris recognition, ensuring that access to the risk assessment system 100 is restricted to authorized users only.

This approach of integrating the registration and data management functionalities directly into the buyer and seller devices 106 offers several advantages. It streamlines the user experience by allowing for immediate and secure registration and authentication, which is essential in a system handling sensitive financial and operational data. Furthermore, by decentralizing these functions, the risk assessment system 100 enhances its resilience and efficiency, as each device becomes a self-sufficient node capable of managing its own security and data interactions with the computer system 102.

In accordance with an additional or alternative embodiment of the present invention, the computer system 102 may be configured in a remotely distributed system. This embodiment contemplates various arrangements for processing and data handling. For instance, the processing tasks traditionally assigned to the central computer system 102 could be performed on a remote server, effectively leveraging cloud computing technologies. This arrangement offers the flexibility of scalable computing resources and enables efficient handling of large data sets, which is particularly beneficial for the complex risk assessment algorithms of the present invention.

Alternatively, the processing could be decentralized and carried out on the processors within the one or more buyer devices 104 or seller devices 106. This distributed processing approach allows for a more resilient system architecture, reducing reliance on a single processing point and potentially enhancing the speed and responsiveness of the risk assessment process.

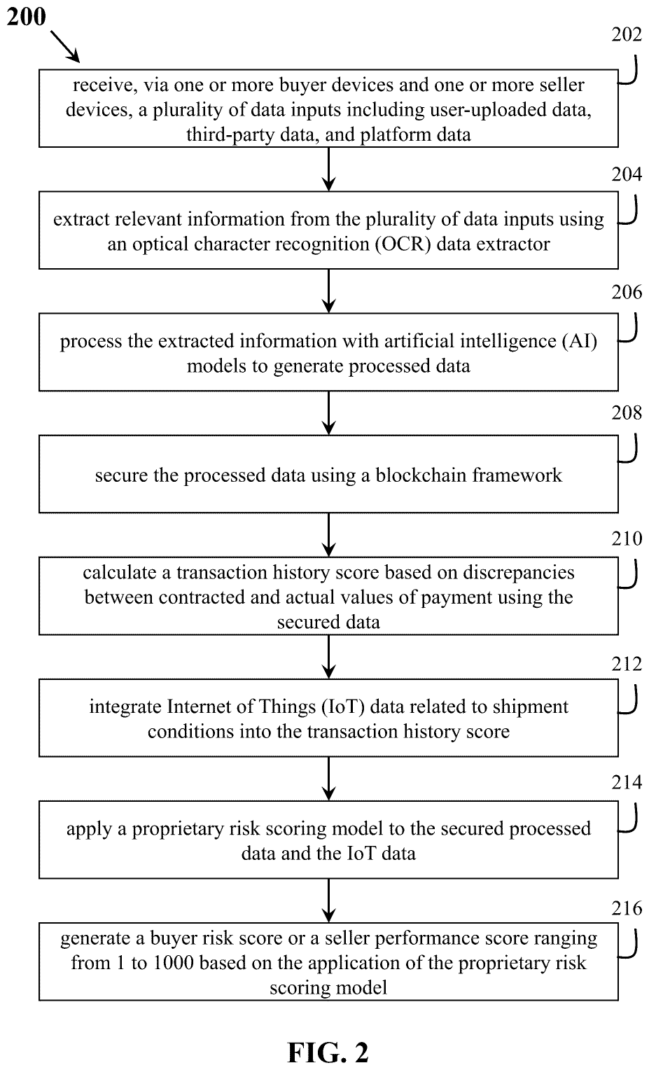

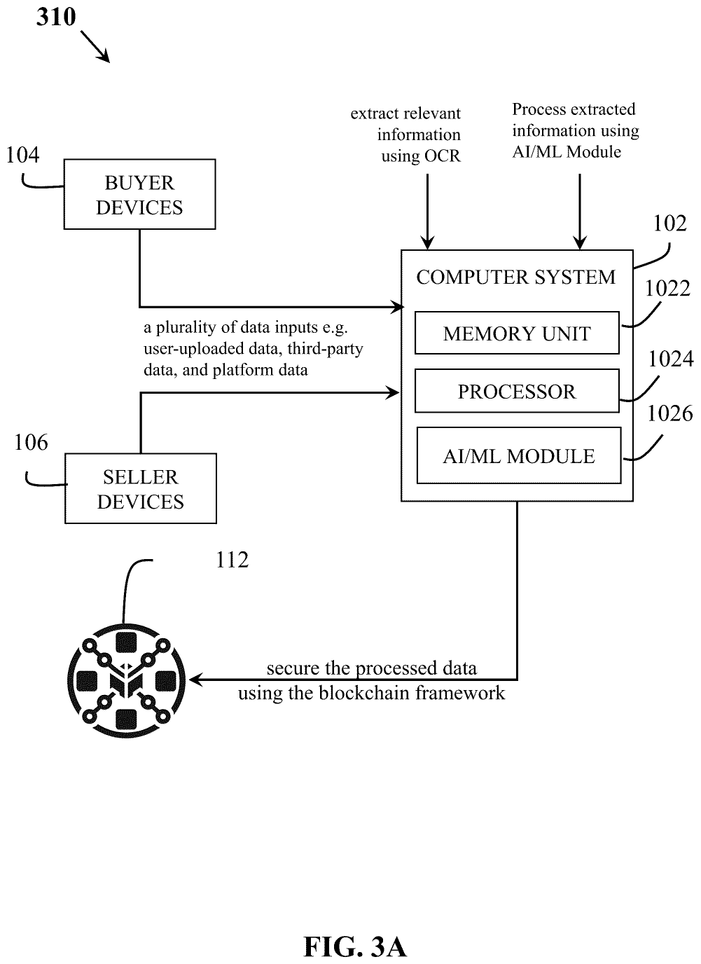

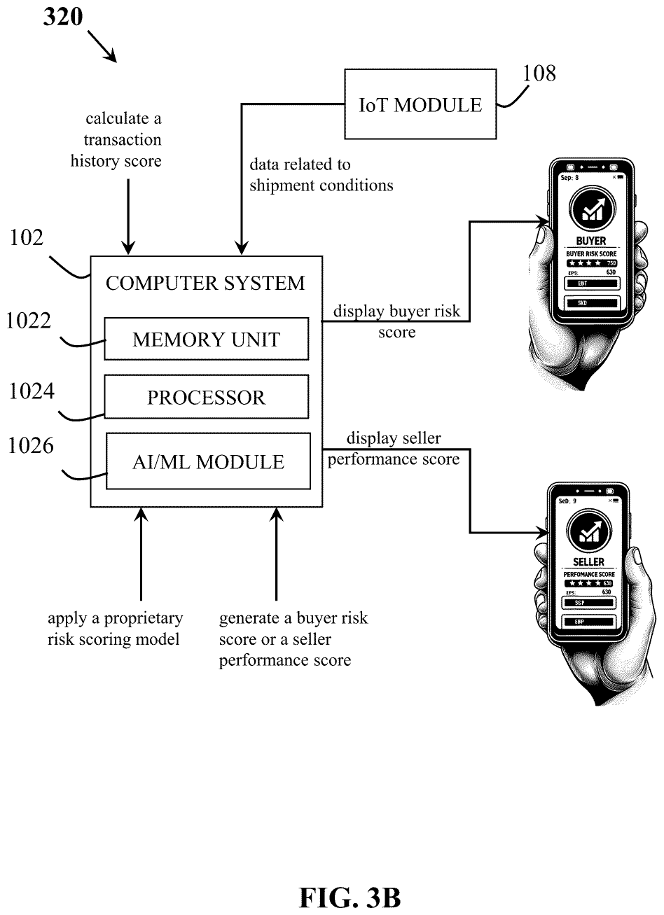

FIG. 2 illustrates risk assessment method 200 (may also be referred as “the computer-implemented method” or “the risk assessment method” or “the method”) for evaluating and scoring small businesses engaged in cross-border trade, in accordance with an embodiment of the present invention. However, the risk assessment method 200 would be better understood in reference of FIG. 3A-3B, side by side. FIG. 3A-3B illustrate information flow diagrams showcasing an exemplary implementation of the risk assessment system 100 and method 200 of FIGS. 1 and 2, in accordance with an embodiment of the present invention. This will provide a clearer understanding of the operational intricacies and the innovative aspects of the present invention.

So, the computer implemented method 200 as shown in FIG. 2, includes:
Step 202 (Receiving Data Inputs): The risk assessment method 200 begins at step 202 (also depicted in FIG. 3A), where the computer system 102 receives a plurality of data inputs via one or more buyer devices 104 and one or more seller devices 106. This step involves collecting diverse data types, including user-uploaded data, third-party data, and platform 101 data. User-uploaded data may encompass bank statements, financial statements, office and warehouse rental agreements, national IDs, passports, and other relevant documents. Third-party data could include credit bureau reports, business registration licenses, and VAT/GST filings. Platform 101 data, in this context, refers to business activity data from the platform 101 referred above (for facilitating and streamlining cross-border trade of food and agriproducts) providing insights into transaction histories and user interactions on the platform 101. This step lays the foundation for the comprehensive risk assessment process by aggregating critical data from various sources.
Step 204 (Extracting Information using OCR): At step 204, the risk assessment method 200 involves extracting relevant information from the received data inputs using an optical character recognition (OCR) data extractor. As illustrated in FIG. 3A, the computer system 102 processes the diverse set of documents and images to convert them into machine-readable text. This step is crucial for digitizing and preparing the data for further analysis, ensuring that all pertinent information is accurately captured and made available for the AI/ML module 1026.
Step 206 (Processing with AI Models): Proceeding to step 206, the risk assessment method 200 utilizes artificial intelligence (AI) models to process the extracted information and generate processed data. In accordance with an embodiment of the present invention, this step, as visualized in FIG. 3A, includes the application of sophisticated machine learning algorithms that analyze the data for patterns, risks, and predictive insights. The AI models are capable of handling both structured and unstructured data, transforming them into actionable intelligence that forms the backbone of the risk scoring process.
Step 208 (Securing Data with Blockchain): At step 208, the risk assessment method 200 secures the processed data using a blockchain framework 112. This step, depicted in FIG. 3A, involves integrating the processed data into an immutable ledger, ensuring the confidentiality and integrity of the data used in the risk assessment process. The blockchain framework 112 provides a secure and tamper-evident environment, enhancing the trustworthiness of the data and the scores generated by the risk assessment system 100. This feature is particularly vital in maintaining data privacy and compliance with international data protection laws and trade regulations.
Step 210 (Calculating Transaction History Score): Then, Step 210 involves calculating a transaction history score based on discrepancies between contracted and actual values of payment using the secured data. Moving to FIG. 3B, this step is a key aspect of the dynamic scoring functionality. It evaluates the financial reliability of the businesses by analyzing their transaction histories, payment behaviors, and any deviations from agreed-upon terms. This step plays a critical role in identifying potential financial risks and contributes significantly to the overall risk assessment.
Step 212 (Integrating IoT Data): In accordance with an embodiment of the present invention, step 212 includes integrating Internet of Things (IoT) data related to shipment conditions into the transaction history score. This step, illustrated in FIG. 3B, underscores the innovative use of real-time, non-financial data in the risk assessment process. IoT data, such as temperature, humidity, shock, and luminance data during shipment, provides valuable insights into the handling and conditions of goods, offering a more comprehensive view of seller performance risks.
Step 214 (Applying Risk Scoring Model): At step 214, the risk assessment method 200 applies a proprietary risk scoring model to the secured processed data and the IoT data. This step, as envisioned in FIG. 3B, involves using a unique algorithm that synthesizes the diverse data points, each assigned a specific weight contributing to the final score. The proprietary risk scoring model is designed to evaluate both financial and operational risks associated with each business, utilizing machine learning techniques to analyze and interpret the data effectively. This step is pivotal in generating a nuanced and accurate risk score, reflecting the true risk profile of the businesses engaged in cross-border trade.
Step 216 (Generating Risk Scores): After, at step 216, the risk assessment method 200 generates a buyer risk score or a seller performance score ranging from 1 to 1000 based on the application of the proprietary risk scoring model. This step, as depicted in FIGS. 3A and 3B, represents the culmination of the risk assessment process. The scores provide a quantifiable measure of risk, facilitating informed decision-making for stakeholders involved in cross-border trade. Higher scores indicate lower risk, while lower scores signal higher risk. The scores are designed to be dynamic, updating in real-time as new data inputs are received, reflecting the risk assessment system's 100 ability to adapt to the changing landscape of international trade.

Furthermore, the risk assessment method 200 may involve displaying the generated buyer risk score and/or seller performance score on user interfaces of the one or more buyer devices 104 and the one or more seller devices 106, enhancing operational efficiency and providing stakeholders with immediate access to critical risk assessment information. This has been illustrated in FIG. 3B.

In summation, the sequential method steps outlined from 202 to 216 and visually explicated in FIGS. 2, 3A, and 3B, thoroughly articulate the operational framework of the risk assessment system 100, as embodied in the present invention. This methodical exposition, from the acquisition of diverse data types to the computation and presentation of risk scores, is meticulously engineered to enhance the precision, security, and effectiveness of the risk assessment process for small businesses engaged in international trade of food and agriproducts. The incorporation of advanced technological components such as optical character recognition, artificial intelligence and machine learning models, blockchain framework 112, and Internet of Things data integration, as detailed in the corresponding information flow diagrams, exemplifies the inventive attributes of this system. These attributes address the prevailing complexities in risk assessment, providing a dynamic, data-centric, and secure methodology for risk management in the domain of international trade. Further, the risk assessment system's 100 facility to exhibit these risk scores on the interfaces of the one or more buyer devices 104 and one or more seller devices 106, as delineated in FIG. 3B, emphasizes its operational efficacy and user-focused design. This integration of sophisticated technology with functional utility encapsulates the core innovation of the present invention, establishing it as a significant advancement in the field of cross-border trade risk assessment.

To further simply the present invention for a skilled addressee, the present invention can be better understood with the help of a working example, which would showcase how it will work in a real-life scenario.

### Working Example

To illustrate the best mode of operation for the present method, consider a hypothetical real-life example involving a small business, ‘FreshFarms LLC,’ based in the United States, engaging in cross-border trade of organic produce with a buyer, ‘HealthyTable,’ located in Canada.

Data Collection and Initial Processing: FreshFarms LLC has recently started using the risk assessment platform 101 associated with the present invention. As FreshFarms LLC initiates a transaction with HealthyTable, the platform 101's computer system 102 begins the risk assessment process. FreshFarms LLC uploads various documents to the platform 101, including its recent bank statements, a copy of its warehouse rental agreement, and its latest financial statement. Additionally, HealthyTable submits its latest credit bureau report and a national identification document as part of the transaction process.

The computer system 102, upon receiving these data inputs via the buyer and seller devices 106, employs its optical character recognition (OCR) module to convert the document images into machine-readable text. The artificial intelligence (AI) models within the risk assessment system 100 then process this extracted information, along with additional third-party data, such as FreshFarms LLC's business registration license and VAT/GST filing statements, obtained from external sources.

Blockchain Security and IoT Data Integration: Concurrently, the blockchain framework 112 of the risk assessment system 100 secures this processed data. This step ensures the integrity and confidentiality of the information, which is critical given the sensitive nature of financial documents. In parallel, the computer system 102 integrates real-time IoT data from FreshFarms LLC's shipment of organic produce to HealthyTable. IoT sensors placed within the shipment provide data on temperature and humidity levels during transit, which are crucial for maintaining the quality of organic produce.

Risk Scoring and Dynamic Updates: Using the proprietary risk scoring model, the computer system 102 calculates a transaction history score for FreshFarms LLC. This score is based on an analysis of discrepancies between contracted and actual values of payment in previous transactions. For instance, FreshFarms LLC has a history of timely payments but recently delayed a shipment due to unforeseen supply chain issues. This information, combined with the IoT data, contributes to a comprehensive seller performance score.

Assuming FreshFarms LLC's overall financial health is stable and its operational performance is consistent, with the exception of the recent delay, the risk assessment system 100 generates a seller performance score of 820 out of 1000. This high score indicates a relatively low risk in dealing with FreshFarms LLC from HealthyTable's perspective.

Real-Time Score Access and Decision-Making: HealthyTable, through its seller device, can immediately access the seller performance score on its user interface. This real-time accessibility to the score enables HealthyTable to make an informed decision about proceeding with the transaction. Given the high score and the transparency of the scoring process, HealthyTable feels confident in continuing its business relationship with FreshFarms LLC.

Adaptation to Changes and Further Transactions: As the trade relationship progresses, any new data or transaction activities are promptly incorporated into the risk assessment system 100. For example, if FreshFarms LLC improves its operational efficiency or experiences a change in its financial status, these changes are reflected in real-time updates to the seller performance score. Similarly, any new transactions or changes in the payment behavior of HealthyTable are also taken into account, dynamically adjusting its buyer risk score as necessary.

Utilization of Scores in Future Transactions: In subsequent transactions, both FreshFarms LLC and HealthyTable benefit from the ongoing risk assessment provided by the risk assessment system 100. FreshFarms LLC uses its high seller performance score as a competitive advantage in negotiations with other potential international buyers. HealthyTable, on the other hand, leverages its buyer risk score to secure better trade terms from other sellers, demonstrating its reliability and financial stability.

To summarize, this working example illustrates the practical application of the computer-implemented method 200 in a real-life scenario, demonstrating how the risk assessment system 100 effectively evaluates and scores small businesses engaged in cross-border trade of food and agriproducts. It showcases the risk assessment system's 100 ability to dynamically adapt to new data, providing ongoing and accurate risk assessments. This example also emphasizes the risk assessment system's 100 comprehensive approach to risk scoring, considering a wide range of data inputs, from financial documents to real-time IoT data, and integrating them into a secure, blockchain-enhanced framework. The real-time accessibility of the risk scores empowers businesses to make informed decisions, enhancing trust and efficiency in cross-border trade relationships.

As detailed above, the present invention focuses on a machine-learning-based risk assessment and scoring engine for evaluating small businesses in cross-border trade of food and agriproducts, and therefore offer a number of advantages:
Comprehensive Risk Assessment: The invention integrates a wide range of data, including financial statements, business activities, and third-party information, providing a holistic view of a business's risk profile.
Dynamic Scoring System: Scores are updated in real-time as new data is provided or transactions occur, ensuring that the risk assessment is current and reflective of the latest information.
Integration of Diverse Data Points: By incorporating both financial and non-financial data, such as IoT data related to shipment conditions, the system offers a more nuanced and accurate assessment of risk.
Advanced Data Processing with AI: The use of artificial intelligence and machine learning algorithms allows for sophisticated analysis of complex data sets, identifying patterns and risks that might not be evident through traditional analysis.
Data Security and Integrity: The implementation of a blockchain framework ensures the confidentiality and integrity of the data used in the risk assessment, providing a secure and tamper-evident record.
Enhanced Decision-Making for Stakeholders: The system facilitates informed decision-making for stakeholders involved in cross-border trade by providing reliable and data-driven risk assessments.
Operational Efficiency: The automation of the risk assessment process streamlines operations, saving time and resources compared to manual risk evaluation methods.
Adaptability and Scalability: The system can be adapted for use in various sectors beyond food and agriproducts, making it versatile and scalable to different markets and business needs.
User-Friendly Interface: The ability to display risk scores on user interfaces of buyer and seller devices enhances the user experience and accessibility of the risk assessment information.
Legal Compliance: The system is designed to adhere to international data protection laws and trade regulations, ensuring legal compliance in its operation.

These advantages highlight the innovative aspects of the present invention and its potential to significantly improve the process of risk assessment in international trade, particularly for small businesses in the food and agriproducts sector.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It is implied that the techniques of the present disclosure might be implemented using a variety of technologies. For example, the methods described herein may be implemented by a series of computer executable instructions residing on a suitable computer readable medium. Suitable computer readable media may include volatile (e.g., RAM) and/or non-volatile (e.g., ROM, disk) memory, carrier waves and transmission media. Exemplary carrier waves may take the form of electrical, electromagnetic or optical signals conveying digital data steams along a local network or a publicly accessible network such as the Internet.

Further, the operations need not be performed in the disclosed order, although in some examples, an order may be preferred. Also, not all functions need to be performed to achieve the desired advantages of the disclosed system and method, and therefore not all functions are required.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A risk assessment system for evaluating and scoring small businesses engaged in cross-border trade, the risk assessment system comprising:
one or more buyer devices associated with respective buyers;
one or more seller devices associated with respective sellers;
an Internet of Things (IoT) module to gather shipment related data as IoT data;
a blockchain framework for securing all data; and
a computer system associated with a platform for facilitating cross-border trade of food and agriproducts, the computer system being connected with the one or more buyer devices and the one or more seller devices, the computer system including:
a processor; and
a memory unit configured to store machine readable instructions that, when executed by the processor, cause the computer system to:
receive, via the one or more buyer devices and the one or more seller devices, a plurality of data inputs including user-uploaded data, third-party data, and platform data;
extract relevant information from the plurality of data inputs using an optical character recognition (OCR) data extractor;
process the extracted information with artificial intelligence (AI) models to generate processed data;
secure the processed data using blockchain framework;
calculate a transaction history score based on discrepancies between contracted and actual values of payment using the secured data;
integrate IoT data related to shipment conditions into the transaction history score;
apply a proprietary risk scoring model to the secured processed data and the IoT data; and
generate a buyer risk score or a seller performance score ranging from 1 to 1000 based on the application of the proprietary risk scoring model.

2. The risk assessment system of claim 1, wherein the user-uploaded data includes at least financial statements, rental agreements, national identification documents, and credit bureau reports.

3. The risk assessment system of claim 1, wherein the third-party data includes at least business registration licenses and VAT/GST filing statements.

4. The risk assessment system of claim 1, wherein the platform data is obtained from a trade platform that facilitates cross-border transactions.

5. The risk assessment system of claim 1, wherein the IoT data includes at least temperature, humidity, shock, and luminance data during shipment.

6. The risk assessment system of claim 1, wherein the computer system is further configured to update the buyer risk score or the seller performance score in real-time based on new data inputs.

7. The risk assessment system of claim 1, wherein the blockchain framework comprises an immutable ledger configured to record the transaction history and processed data.

8. The risk assessment system of claim 1, wherein the proprietary risk scoring model includes pre-trained machine learning models configured to analyze the processed data and IoT data.

9. The risk assessment system of claim 1, wherein user interfaces on the one or more buyer devices and the one or more seller devices are configured to display the buyer risk score or the seller performance score, respectively.

10. The risk assessment system of claim 9, wherein the one or more buyer devices and one or more seller devices are selected from a laptop, mobile, a wearable watch or band, a desktop and a portable handheld device, having computing capabilities.

11. A computer-implemented method for evaluating and scoring small businesses engaged in cross-border trade of food and agriproducts, the method comprising:
receiving, via one or more buyer devices and one or more seller devices, a plurality of data inputs including user-uploaded data, third-party data, and platform data;
extracting relevant information from the plurality of data inputs using an optical character recognition (OCR) data extractor;
processing the extracted information with artificial intelligence (AI) models to generate processed data;
securing the processed data using a blockchain framework;
calculating a transaction history score based on discrepancies between contracted and actual values of payment using the secured data;
integrating Internet of Things (IoT) data related to shipment conditions into the transaction history score;
applying a proprietary risk scoring model to the secured processed data and the IoT data; and
generating a buyer risk score or a seller performance score ranging from 1 to 1000 based on the application of the proprietary risk scoring model.

12. The method of claim 11, wherein the user-uploaded data includes at least financial statements, rental agreements, national identification documents, and credit bureau reports.

13. The method of claim 11, wherein the third-party data includes at least business registration licenses and VAT/GST filing statements.

14. The method of claim 11, wherein the platform data is obtained from a trade platform that facilitates cross-border transactions.

15. The method of claim 11, wherein the IoT data includes at least temperature, humidity, shock, and luminance data during shipment.

16. The method of claim 11, further comprising updating the buyer risk score or the seller performance score in real-time as new data inputs are received.

17. The method of claim 11, wherein the blockchain framework comprises an immutable ledger configured to record the transaction history and processed data.

18. The method of claim 11, wherein the proprietary risk scoring model includes pre-trained machine learning models configured to analyze the processed data and IoT data.

19. The method of claim 11, further comprising displaying the buyer risk score or the seller performance score on user interfaces of the one or more buyer devices and the one or more seller devices, respectively.

20. The method of claim 19, wherein the one or more buyer devices and one or more seller devices are selected from a group comprising a laptop, mobile, a wearable watch or band, a desktop, and a portable handheld device with computing capabilities.
